(19) United States
(12) Patent Application Publication
(10) Pub. No.: US 2019/0376670 A1
(43) Pub. Date: Dec. 12, 2019

(54) SOFFIT LIGHT AND METHOD OF ASSEMBLY

(71) Applicants: Gary R. Ludwig, Hudsonville, MI (US); Qingqi Xu, Huizhou City (CN)

(72) Inventors: Gary R. Ludwig, Hudsonville, MI (US); Qingqi Xu, Huizhou City (CN)

(73) Assignee: ITC Incorporated, Hudsonville, MI (US)

(21) Appl. No.: 16/004,216

(22) Filed: Jun. 8, 2018

(51) Int. Cl. F21V 21/02; F21V 21/096

(52) U.S. Cl. CPC F21V 21/02; F21Y 2115/10; F21V 21/096

(57) ABSTRACT

An soffit light assembly includes a housing having a top surface, a first and second inner walls extending downward from the top surface, a first and second outer walls spaced away from the first and second inner walls respectively, and a lip extending along an inner surface of an outer wall. An end cap is positioned in slidable engagement with an end of the housing and includes a magnet positioned within a recess of the end cap sidewall. The end cap, housing, and a light source are connected together at a single connection point on each end of the housing.

### FIELD OF INVENTION

The present invention relates to the field of mounted surface lighting and more specifically to an overhead light assembly and method of assembly.

### BACKGROUND

Work surfaces and work stations, such as desks and the like, are commonly configured with overhead storage, such as shelves, cabinets, or other similar structures. While these overhead storage structures provide useful space, they also block and reduce other overhead lighting that would otherwise illuminate the work space.

In order to properly illuminate work spaces that include overhead structures, numerous under-cabinet lighting solutions have been developed. However, many of these solutions share certain drawbacks.

First, many common lighting solutions for under-cabinet lighting are fixed in a single location, such as mounted directly to the underside of the cabinet. This is often done by screwing or bolting the lighting assembly to the overhead structure. However, by fixing the location of the light, users are unable to move the light to its most desirable and effective location.

In addition, many common solutions lack a simple and effective method of assembly. Often, under-cabinet lighting solutions include numerous parts and components that complicate assembly and add to the cost of both the lighting and the assembly.

Accordingly, an improved soffit light assembly and method of assembly is needed.

### SUMMARY

A soffit light assembly is generally presented. The soffit light assembly includes an elongate housing having a top surface, a first and second inner walls extending downward from the top surface, a first and second outer walls spaced away from the first and second inner walls respectively, and a lip extending along an inner surface of an outer wall. An end cap may be positioned in slidable engagement with an end of the housing. The end cap may include an upper surface, a first and second sidewall extending downward from the upper surface, and a slot in an outer portion of at least one of the first and second sidewalls. The slot may be aligned with the lip of the housing and configured to slidably engage the lip. A magnet may be positioned within a recess in a sidewall. A light source may be connected to an underside of the top surface. The end cap is connected the housing by a fastener extending through the upper surface of the end cap and through the top surface of the housing.

In an embodiment, a method of assembling a soffit light assembly is presented. The method includes the steps of: (1) providing a housing having a top surface, a first and second inner walls extending downward from the top surface, a first and second outer walls spaced away from the first and second inner walls respectively, and a lip extending along an inner surface of an outer wall; (2) connecting a light source to an underside of the top surface; (3) providing an end cap comprising an upper surface, a first and second sidewall extending downward from the upper surface, a slot in an outer portion of at least one of the first and second sidewalls, and a magnet positioned within a recess in a sidewall; (4) slidably engaging the end cap with the housing, wherein the lip is aligned and slidably engaged with the slot; and (5) fastening the end cap to the housing.

In an embodiment, the light source is an LED light. The fastener comprises a screw extending through a hole in the end cap and engaged with an opening in the housing. The screw extends through the light source and connects the light source to the housing and further provides an electrical ground for the light source.

In an embodiment, the magnet comprises a lower portion, an upper portion extending from the lower portion, and a ridge formed along the intersection of the lower portion and upper portion. The ridge is configured to abut the lip when the end cap is positioned in slidable engagement with an end of the housing. A portion of the magnet may be exposed along the upper surface of the end cap.

### BRIEF DESCRIPTION OF THE DRAWINGS

The operation of the invention may be better understood by reference to the detailed description taken in connection with the following illustrations, wherein:

FIG. 1 illustrates a bottom perspective view of a soffit light assembly and connected power supply and switch;

FIG. 2 illustrates a top side view of a soffit light assembly;

FIG. 3 illustrates a top perspective view of a soffit light assembly;

FIG. 4 illustrates a top perspective end view of a soffit light assembly having an end cap and magnet partially removed from the housing;

FIG. 5 illustrates a top perspective view of an end cap and magnet for a soffit light assembly;

FIG. 6a illustrates a bottom perspective view of a portion of a housing for a soffit light assembly;

FIG. 6b illustrates a cross-sectional view of a housing for a soffit light assembly;

FIG. 7a illustrates a top side view of a magnet for a soffit light assembly;

FIG. 7b illustrates a top perspective view of a magnet for a soffit light assembly;

FIG. 8 illustrates a bottom end view of a soffit light assembly housing and light source mounted therein; and

FIG. 9 illustrates a bottom end view of a soffit light assembly having a light source and lens connected to the housing.

### DETAILED DESCRIPTION

Reference will now be made in detail to exemplary embodiments of the present invention, examples of which are illustrated in the accompanying drawings. It is to be understood that other embodiments may be utilized and structural and functional changes may be made without departing from the respective scope of the invention. Moreover, features of the various embodiments may be combined or altered without departing from the scope of the invention. As such, the following description is presented by way of illustration only and should not limit in any way the various alternatives and modifications that may be made to the illustrated embodiments and still be within the spirit and scope of the invention.

A soffit light assembly 10 is generally presented. The soffit light assembly 10 may be configured to be mounted to a surface, such as an overhead structure, and emit light in a downward direction to a work surface or area beneath the mounting position.

As used herein, the term “soffit” shall mean the underside of an architectural structure, such as the underside of a cabinet, shelf, wall, structural support, or any structure. However, it will be appreciated that the soffit light assembly may be mounted to any appropriate structure and configured to emit light in any desired direction.

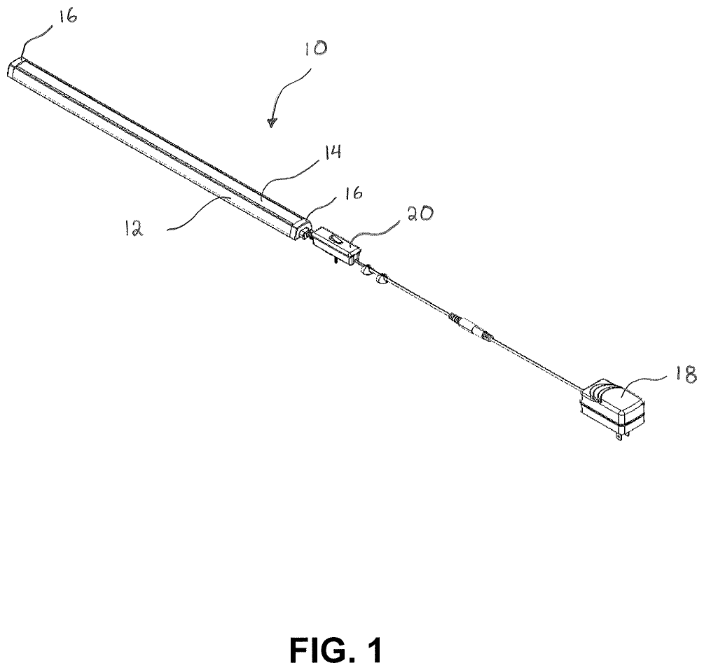

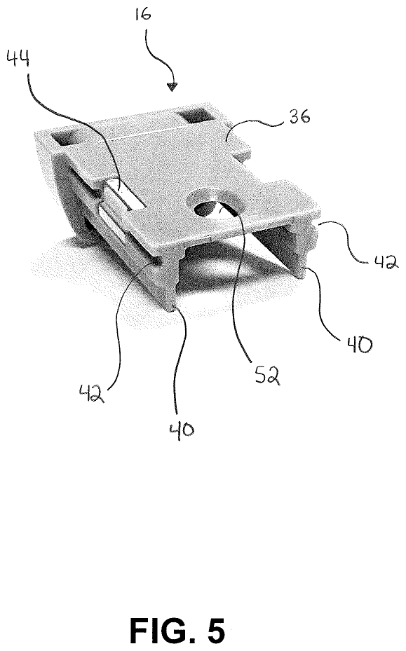

With reference to FIGS. 1-9, the soffit light assembly generally includes a housing 12, a lens 14 connected to the housing, and end caps 16 positioned at respected ends of the housing 12. Other components, such as those described herein, may also be included in the assembly 10. The soffit light assembly 10 may be configured to have a simplified assembly, as described in further detail below.

As shown in FIG. 1, the soffit light assembly 10 may be connected to a power source 18. The power source 18 may include a plug configured to be inserted into a standard outlet. In an embodiment, the power source 18 may convert AC power received from the electrical outlet to DC power configured to power a light source in the soffit light assembly 10. A switch 20 may be connected to the power source 18, such as in-line with the power source connection to the soffit light assembly 10. The switch 20 may turn power to the light on and off.

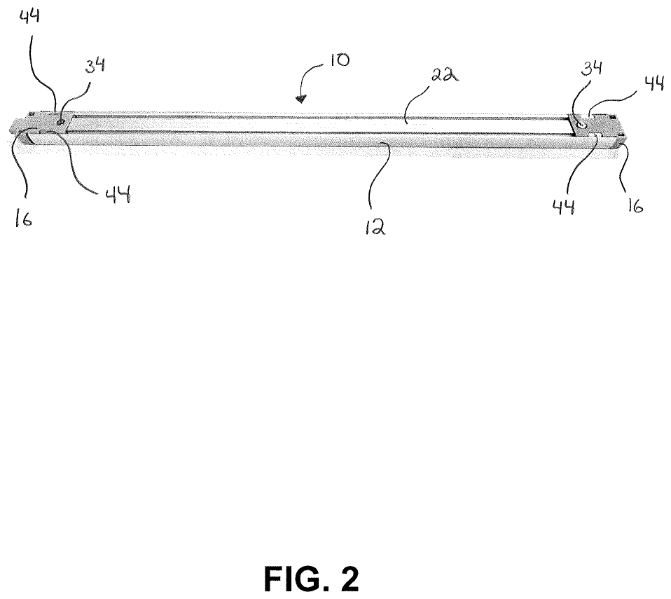

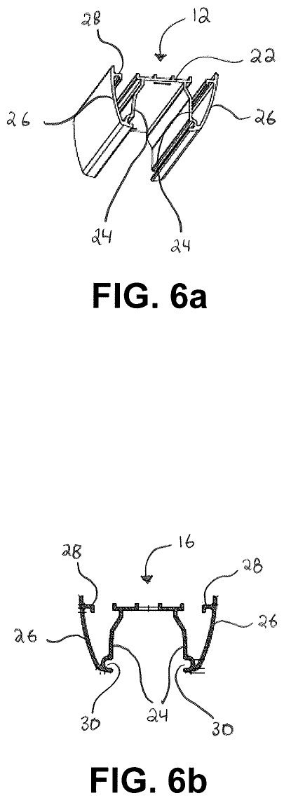

The housing 12 for the soffit light assembly 10 is best illustrated in FIGS. 2-6, with FIGS. 6a and 6b illustrating internal and cross-sectional views of the housing 12. As shown, the housing 12 may be an elongate structure formed through any appropriate process, such as extruded, and composed of any appropriate material. In an embodiment, the housing 12 may be an extruded aluminum housing having generally consistent shape and properties along its length.

The housing may generally comprise a top surface 22 and a first and second inner wall 24 extending downward from the top surface 22. The inner walls 24 may be spaced apart to form a channel therebetween. A first and second outer wall 26 may be positioned exterior to and spaced away from the inner walls 24. For example, as shown in FIGS. 6a and 6b, the outer walls 26 may be angled toward the inner walls 24 and the outer and inner walls 24, 26 may intersect at or near the a bottom portion of the walls 24, 26. However, it will be appreciated that other configurations of the walls 24, 26 may be used to provide an outer wall 26 that is spaced away from an inner wall 24, such as a spacer or alternative connecting portion positioned between them.

The housing 12 may include a lip 28. The lip 28 may comprise a protrusion along an inner length of an outer wall 26 toward the respective inner walls 24. The lip 28 may assist in retaining the end caps 16 and related components in place, as described in further detail below. The housing may further include a groove 30 positioned in each inner wall 24. The respective grooves 30 may be located on the inner portions of the inner walls 24, within the channel between them.

The housing 12 may include an opening 32 positioned near each end. The opening 32 may be threaded and configured to receive a screw 34 or threaded bolt therethrough. The single opening 32 at each end may be configured to provide a complete connection for the housing 12, end caps 16, lens 14, and any other components or parts.

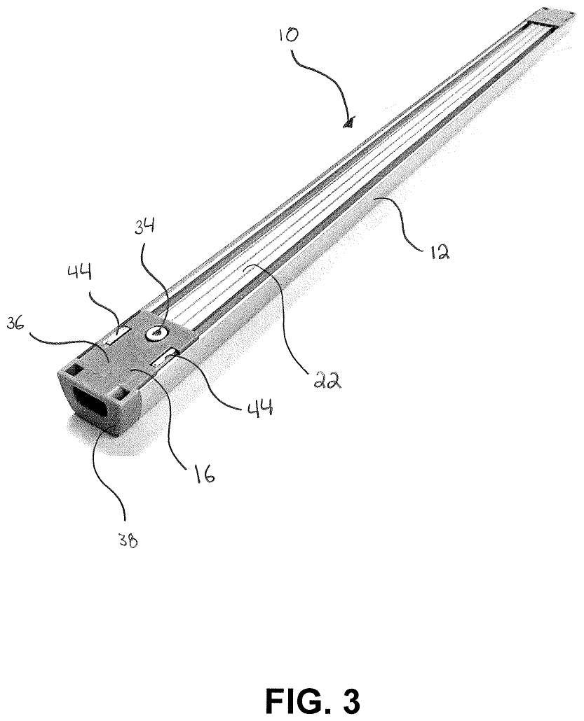

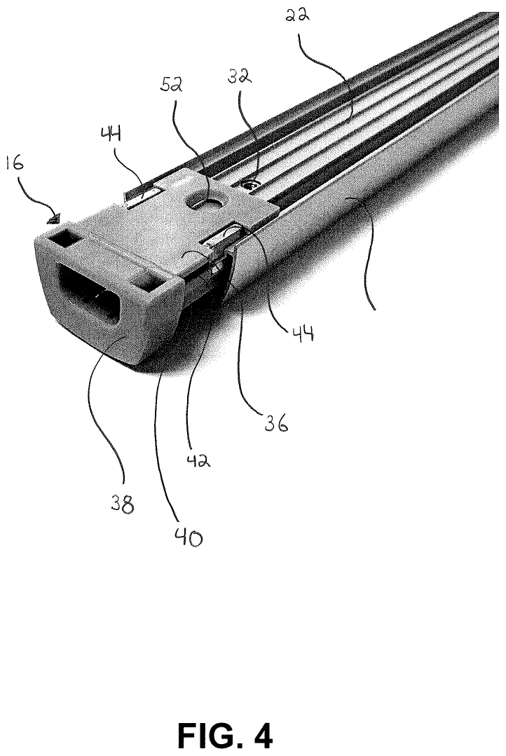

With reference to FIGS. 3 and 4, the soffit light assembly 10 may include end caps 16 positioned at each end of the housing 12. The end caps 16 may be generally configured to insert into the ends of the housing 12 and connect thereto. The end caps 16 may comprise an upper surface 36, an outer face 38 connected to an outer side of the upper surface 36 and extending downward therefrom, and a pair of sidewalls 40 extending downward from the upper surface 36 along the length or a portion of the length of the upper surface 36. The sidewalls 40 may include a slot 42 therein. The slot 42 may be sized and shaped to receive the lip 28 therein to connect the end cap 16 and housing 12 in a slidable engagement.

The end cap 16 may be configured to hold a magnet 44 and position the magnet 44 along the top surface 22 when the end cap 16 is connected to the housing. The magnet 44 may be used to connect the soffit light assembly 10 to a metallic or magnetic surface. In an embodiment, the end cap 16 may include a recess along the sidewalls 40 configured to receive a magnet 44 therein. The recess may include a shelf or surface for the magnet 44 to rest on, and the recess may allow the magnet to be generally aligned with the slot 42.

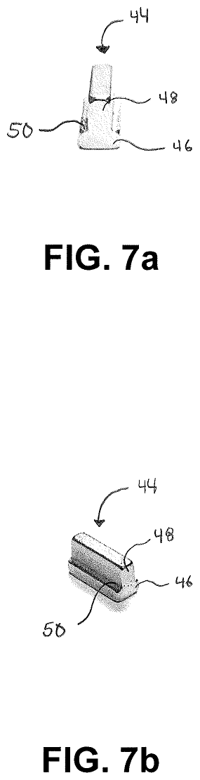

The magnet 44 may be configured to be retained within the slot 42 by the lip 28 when the end cap 16 is connected to the housing 12. As shown in FIGS. 7a and 7b, the magnet 44 may be T-shaped having a lower portion 46 and an upper portion 48 extending from the lower portion 46. The intersection of the lower and upper portions 46, 48 may form a ridge 50 that is configured to abut the lip 28 and retain the magnet within the recess. When nested in the recess, the ridge 50 may generally align with the slot 42. While the magnet 44 is shown and described as being T-shaped, it will be appreciated that other shapes of the magnet may be used.

FIG. 4 best illustrates the engagement between the end cap 16, magnet 44, and housing 12. The sidewalls 40 may be configured to insert into a space between the inner and outer walls 26, 28. The magnet 44 may be positioned in the recess in the sidewalls 40 with the ridge 50 aligned with the slot 40. The lip may insert through the slot 40 and along the ridge 50 to retain the end cap 16 in slidable engagement with the housing 12 while also holding the magnet 44 in place. A top portion of the magnet 44 may remain exposed along the top surface 22 to allow for a magnetic connection of the soffit light assembly 10.

The end cap 16 may include a through-hole 52 in the upper surface 36 for connecting the end cap 16 to the housing. As shown in FIG. 3, the screw 34 may be inserted through the through-hole 52 and into the opening 32 to hold the end cap 16 and magnet 44 in place.

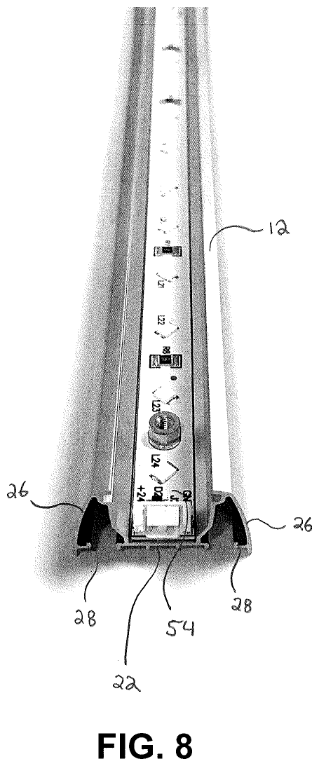

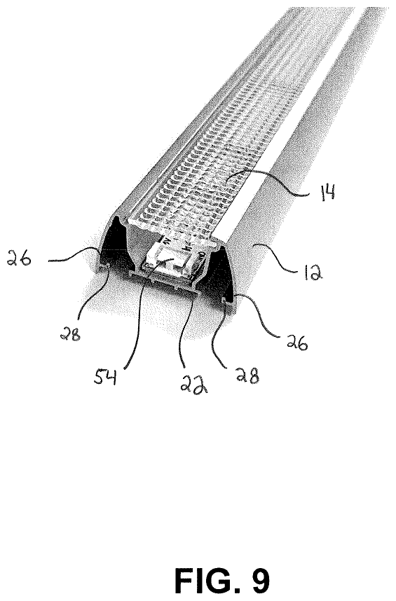

With reference to FIGS. 8 and 9, a light source 54 may be positioned within the channel between the inner walls 24. The light source 54 may be any appropriate light source, such as a light emitting diode (“LED”) light strip having a plurality of LEDs. The light source 54 may be connected to or adhered to the underside of the top surface 22 and arranged to emit light in a downward direction when the soffit light assembly 10 is connected to an overhead structure. The screw 34 may extend through the top surface 22 through the light source 54 to connect the light source 54 to the housing 12. The screw 34 may further provide an electrical ground contact for the light source 54 by maintaining contact with both the housing 12 and the light source 54. The light source 54 may be additionally snapped, glued, or otherwise connected or adhered to the underside of the housing 12.

The lens 14 may be inserted into the groove 30 and extend along the length of the housing 12. The lens may be configured to evenly disperse the light emitted from the light source 54. In an embodiment, the lens may be formed of an acrylic material and manufactured using an injection molding process, instead of other typical manufacturing methods. The injection molded lens may include a plurality of bubble optic pads, formed through a high quality diamond ground manufacturing process. In some cases, pairing of lenses with linear LED lights may yield yellow lines caused by a lack of sharpness at the intersection of the optic shapes. However, the injection molded and diamond ground acrylic lens provides the best light distribution without any yellow colored lines on the surface when paired with an LED linear light source.

In use, the soffit light assembly 10 may be assembled using the following steps. First, a housing 12 may be provided. The housing 12 may comprise an elongated extrusion having a top surface 22, inner walls 24, and outer walls 26 spaced away from the inner walls 24. A lip 28 may extend inward from each of the outer walls 26. A light source 54 may be connected to the underside of the top surface 22, and a lens may be inserted into a groove 30 in the inner walls 24. A first end cap 16 may be inserted into a first end of the housing 12. The end cap 16 having an upper surface 36 and sidewalls 40 extending downward from the upper surface 36 may be inserted into an end of the housing 12. A magnet 44 may be inserted into a recess in the sidewalls 40 and aligned with a groove in the sidewalls 40. The groove 40 may be aligned with the lip 28 to retain the end cap 16 and magnet 44 in slidable engagement with the housing 12. A screw 34 may be inserted through a through-hole 52 in the end cap 16 and into an opening 32 in the housing 12. As second end cap 16 may be connected to ta second end of the housing 12 in a similar manner as described above.

Although the embodiments of the present invention have been illustrated in the accompanying drawings and described in the foregoing detailed description, it is to be understood that the present invention is not to be limited to just the embodiments disclosed, but that the invention described herein is capable of numerous rearrangements, modifications and substitutions without departing from the scope of the claims hereafter. The claims as follows are intended to include all modifications and alterations insofar as they come within the scope of the claims or the equivalent thereof.

Having thus described the invention, we claim:

1. A soffit light assembly comprising:
an elongate housing comprising:
a top surface;
a first and second inner walls extending downward from the top surface;
a first and second outer walls spaced away from the first and second inner walls respectively; and
a lip extending along an inner surface of an outer wall;
an end cap in slidable engagement with an end of the housing, the end cap comprising:
an upper surface;
a first and second sidewall extending downward from the upper surface;
a slot in an outer portion of at least one of the first and second sidewalls, the slot aligned with the lip and configured to slidably engage the lip;
a magnet positioned within a recess in a sidewall;
a light source connected to an underside of the top surface;
wherein the end cap is connected the housing by a fastener extending through the upper surface of the end cap and through the top surface of the housing.

2. The soffit light assembly of claim 1, wherein the light source is an LED light source.

3. The soffit light assembly of claim 1, wherein the magnet comprises a lower portion, an upper portion extending from the lower portion, and a ridge formed along the intersection of the lower portion and upper portion.

4. The soffit light assembly of claim 3, wherein the ridge is configured to abut the lip when the end cap is positioned in slidable engagement with an end of the housing.

5. The soffit light assembly of claim 1, wherein the fastener is a screw extending through a hole in the end cap and engaged with an opening in the housing.

6. The soffit light assembly of claim 5, wherein the screw extends through the light source and connects the light source to the housing and further wherein the screw provides an electrical ground for the light source.

7. The soffit light assembly of claim 1 further comprising a second end cap in slidable engagement with a second end of the housing.

8. The soffit light assembly of claim 1, wherein a portion of the magnet is exposed along the upper surface of the end cap.

9. The soffit light assembly of claim 1 further comprising a lens positioned between the first inner wall and the second inner wall.

10. The soffit light assembly of claim 1, wherein the outer walls are angled toward the inner walls.

11. The soffit light assembly of claim 1, wherein the outer walls are connected to the inner walls.

12. The soffit light assembly of claim 1 further comprising a second lip extending along an inner surface of a second outer wall.

13. A method of assembling a soffit light assembly, the method comprising:
providing a housing having a top surface, a first and second inner walls extending downward from the top surface, a first and second outer walls spaced away from the first and second inner walls respectively, and a lip extending along an inner surface of an outer wall;
connecting a light source to an underside of the top surface;
providing an end cap comprising an upper surface, a first and second sidewall extending downward from the upper surface, a slot in an outer portion of at least one of the first and second sidewalls, and a magnet positioned within a recess in a sidewall;
slidably engaging the end cap with the housing, wherein the lip is aligned and slidably engaged with the slot; and
fastening the end cap to the housing.

14. The method of claim 13 further comprising inserting a lens into a groove in the two inner walls.

15. The method of claim 13, wherein the light source is an LED light source.

16. The method of claim 13, wherein the magnet comprises a lower portion, an upper portion extending from the lower portion, and a ridge formed along the intersection of the lower portion and upper portion.

17. The method of claim 16, wherein the ridge is configured to abut the lip when the end cap is positioned in slidable engagement with an end of the housing.

18. The method of claim 13, wherein fastening the end cap to the housing comprises inserting a screw through the end cap and through the top surface of the housing.

19. The method of claim 18, wherein the screw is inserted through the light source to connect the light source to the housing and to provide an electrical ground for the light source.

20. The method of claim 13, wherein a portion of the magnet is exposed along the upper surface of the end cap.
